(19) United States
(12) Patent Application Publication
(10) Pub. No.: US 2005/0125732 A1
(43) Pub. Date: Jun. 9, 2005

(54) Method and apparatus for generating a personalized content selection user interface incorporating multiple types and sources of content

(75) Inventors: Reem Safadi, Horsham, PA (US); Christopher Seymour, Richooro, PA (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(73) Assignee: General Instrument Corporation, Horsham, PA (US)

(21) Appl. No.: 10/728,537

(22) Filed: Dec. 5, 2003

(51) Int. Cl. G09G 5/00

(52) U.S. Cl. 715/700

(57) ABSTRACT

The present invention is a method and apparatus for providing a content selection GUI [120] incorporating a first type of content from a first type of source [116] and a second type of content from a second type of source [110]. Content selections [402-420] from an active user profile, which may include content selections including both the first type of content and the second type of content, are analyzed and recorded into a user profile data structure [460]. The content selections of the active user profile [402-420] are then analyzed to generate a favorites list, which is presented to the user via the content selection GUI [120].

### FIELD OF THE INVENTION

The present invention relates to the field of electronic content, and in particular, to providing a personalized integrated content selection user interface incorporating various types and sources of content.

### BACKGROUND OF THE INVENTION

In the early years of television, viewers were offered an extremely limited number of channels. In many areas of the country, over-the-air broadcasting was, and remains, limited to about 6 VHF channels and several UHF channels. With such few options, viewers could easily select a television program by simply “channel-surfing” the handful of available channels.

The advent of cable television and satellite television, however, has presented users with hundreds of channels available for viewing. Furthermore, with new developments constantly taking place in the industry, the number of channels will only increase with each step of the evolution of television. The digital televisions of the near future will be a marriage between television technology and computer technology, including microprocessors, interconnectivity with other computers, and connectivity to computer peripherals such as printers. These near-future televisions will also likely provide as many as a thousand channels, as well as offering various different types of content such as video on demand (VOD) content, near video on demand (NVOD) content, audio on demand content, live content, Internet content, Personal Video Recorder (PVR) or Digital Video Recorder content, and possibly other types of content yet to be discovered. Hereinafter, the term “content” will be understood to refer not only to different sources of content, such as television channels as they are presently understood, but also including these aforementioned different types of content.

With such a large amount of content and possibly an exponential increase in the types and amount of content on the horizon each with its own navigational Graphical User Interface (GUI), a great challenge exists to provide a seamless and integrated content selection method that will support an intelligent, user-friendly and intuitive experience using appropriate navigational graphical user interface (content selection GUI) to assist users in content selection. A content selection GUI is a user interface that presents content descriptive information in a graphical form to enable the user to navigate through the information, irrespective of the source of content or its type. Current electronic content guides suffer from many shortcomings, especially when anticipating the needs of future televisions. For example, current electronic content guides display available channels in a time-based schedule grid. While such an electronic content guide may operate well with a limited number of channels, such an electronic guide may prove quite burdensome if the user must tediously scroll down to individually view thousands of entries in a time-based schedule grid. Indeed, such an electronic guide in a one thousand plus channel setting may result in the user spending most of the time viewing the guide rather than enjoying selected content. This frustrating process may not only lead to customer dissatisfaction, but ultimately, to increased customer churn.

Another shortcoming with current electronic guides is that current electronic guides only report content description information for a single type of content. This content description information may include, but is not limited to, scheduling information, title, rating, names of participating actors, or any other information associated with the content. Because the televisions of the near future will likely receive multiple types of content, a user operating current technology would have to view a single source listing guide for each type of content to gain an accurate picture of all the content available. Many guides for each type of content, along with the thousands of channels that may be available, will undoubtedly frustrate tomorrow's television user to the point where watching television may require so much effort on the user's part that it is no longer enjoyable to the user.

Yet another shortcoming with current electronic guides is the extra steps required by the user to create a favorites list. These favorites lists are usually created by a user selecting a channel via a selection device, and then entering a command via a user interface to add the channel to the favorites list. To delete a channel from the favorites list, the user typically enters the user interface for editing the favorites list, and manually enters a command into the selection device to delete the channel from the favorites list. Because of the extra steps required to add and delete channels from the favorites list, users may find the typical favorite list creation process to be burdensome and time consuming, especially in the case of children users.

Still another problem with current electronic guides is the lack of personalization available. Typically, a household utilizing a content device, such as a television device, involves more than one user. For example, one or more children along with two adult parents may view a single household television device located in a living area either together or individually. The favorites list provided by current electronic guides may prove problematic in such a shared usage situation because only one favorites list is usually available per television device. Because each member of the television household will undoubtedly have different tastes in television content, the favorites list will therefore not be specific to each user. This problem may result in wasting each user's time by forcing the user to peruse channels that were not added by that particular user to the favorites list. Additionally, if a large amount of users regularly view a television device, such as a television device in a student dormitory lobby or office break room, the favorites list may become so large and a reflection of so many users' tastes that it is virtually useless.

Therefore, there is an urgent need in the art for a method and apparatus for generating a content guide that supports a user-friendly content selection GUI with the capability of handling information regarding an enormous amount of available content. Additionally, there is a need for a content guide that incorporates multiple types and sources of content, content description information about which is presented on the content selection GUI. There is also a need in the art for a content guide supporting a content selection GUI that provides an easy process for generating and maintaining a list of favorite content selections. Furthermore, there is a need in the art for personalization of such a content selection GUI for one or more user profiles to further assist in channel and content selection.

### SUMMARY OF THE INVENTION

The present invention overcomes the above-referenced deficiencies in the prior art by providing a method and apparatus for generating a content guide that supports a content seelction GUI incorporating multiple types and sources of content. A content list application supporting the content selection GUI receives a first content description information about a first type of content from a first content source, and second content description information about a second type of content from a second content source. The user-profiling feature of the present invention then receives the content selections of the active user profile and generates a list of favorite content selections including first content and second content. This list of favorite content selections is then presented in the form of a user-friendly content selection GUI to the user via a display device.

By presenting the most frequent content selections to the user upon request, regardless of type or source, the present invention assists the user in the content selection process by narrowing the choices of content from possibly thousands of choices available, without requiring extra effort by the user. The list of favorite content selections will become increasingly fine-tuned to the user's tastes as a result of analysis of the content selections of the user profile. Furthermore, because the present invention incorporates multiple sources of content, instead of just receiving content from one source, the user does not have to peruse a large amount of information about the other sources of content. The end result is an easier, less painful content selection process that becomes increasingly fine-tuned to the user's preferences over time, resulting in a more pleasurable viewing experience.

### BRIEF DESCRIPTION OF THE DRAWINGS

For a fuller understanding of the present invention, reference is made to the following description taken in connection with the accompanying drawings, in which:

FIG. 1 is a block diagram of an exemplary system in accordance with an embodiment of the present invention.

FIG. 2 is a flow diagram illustrating the generation of the list of favorite content selections feature in accordance with an embodiment of the present invention.

FIG. 3 is a block diagram of an exemplary data structure utilized to store and maintain the list of favorite content selections received via the content selection GUI in accordance with an embodiment of the present invention.

FIG. 4 is a block diagram of the exemplary data structure utilized in accordance with the user profile embodiment of the present invention.

### DETAILED DESCRIPTION

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing a preferred embodiment of the invention. It should be understood that various changes may be made in the function and arrangement of elements without departing from the spirit and scope of the invention as set forth in the appended claims.

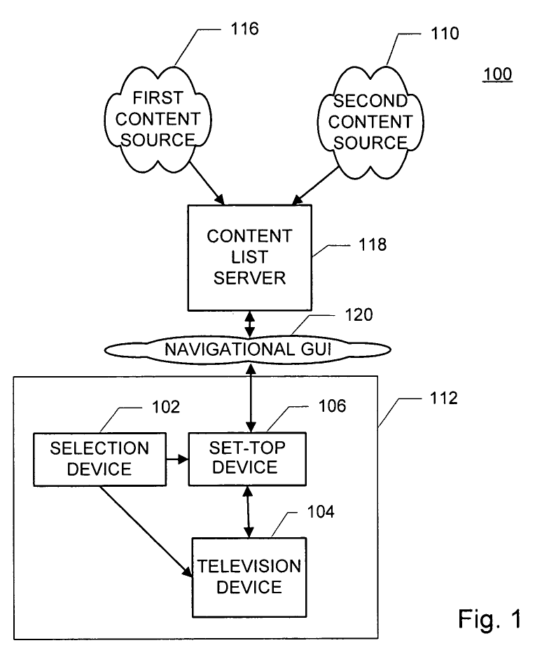

FIG. 1 is a block diagram of an exemplary system in accordance with an embodiment of the present invention. The exemplary system 100 supports a content selection GUI incorporating first content description information about a first type of content from a first content source 116, and second content description information about a second type of content from a second content source 110. To provide the content selection GUI in accordance with the present invention, exemplary system 100 includes a selection device 102, a set-top device 106, a television device 104, a first content source 116, a content list application or server 118, and a second content source 110. Those skilled in the art will recognize that the selection device 102, the set-top device 106, and television device 104 comprise components of a network environment 112 located at the location of a viewer, for example, at a home or office. Furthermore, those skilled in the art will recognize that system 100 may include numerous other content sources in addition to the first content source 116 and the second content source 110, said other content sources comprising various other types of content.

Television device 104 is a device configured to display television signals in a variety of formats, such as analog signals, digital television formats, or high-definition formats. The television device 104 may display signals via various technologies known in the art, such as standard cathode ray technology, liquid crystal display technology, liquid plasma display technology, or projection techniques. Those skilled in the art will recognize that television device 104 may comprise a device serving other primary functions besides the display of television signals, such as a personal computer, or any other electronic device with the capability to display signals received from either a television network or other network.

The set-top device 106 is a consumer electronics device for communicating between the television device 104 and the first content source 116. In the exemplary embodiment, set-top device 106 receives encoded signals comprising first content from the first content source 116, and decodes the signal for display on television device 104. Set-top device 106 is communicatively coupled to the television device 104 either via a wired or wireless connection. The set-top device 106 may receive content selection commands from a user profile via a selection device 102, or another device capable of receiving such commands, and may transmit these content selection commands to the content list application 118.

Content selection GUI 120 is a conduit for inducing content selection by presenting content description information to a user in a graphical format. In response to viewing the graphical format of the content description information in the navigational GUI, a user may indicate a content selection indication by manipulating the content selection device 102 in response to the presentation of the content selection GUI on television device 104. Content selection GUI 120 may be part of the content list application 118, within set-top device 106, or within any external device enabling communication between the content list application 118 and set-top device 106.

Selection device 102 may comprise various components for receiving the content selection indication from a user, including but not limited to, an activation of a button on a selection device (e.g., remote controller), a touch sensitive display, a keypad, a microphone, or a camera. For example, the content selection GUI 120 may present various on-screen visual displays on television device 104 in response to which, and in conjunction with selection device 102, a user may indicate a content selection indication. Other processes for generating a content selection indication include, but are not limited to, a drag and drop procedure or a speech command entered into selection device 102 in response to a display presented by the content selection GUI 120.

In the exemplary embodiment, first content source 116 and second content source 110 comprise equipment necessary for providing a first type of content and a second type of content, respectively. The first type of content or the second type of content may comprise, but is not limited to, cable television content, video on demand (VOD) content, near video on demand (NVOD) content, audio on demand content, live content, Internet content, and PVR content.

Furthermore, the first type of content and the second type of content are associated with a first type of content description information and a second type of content description information. This content description information may include, but is not limited to, scheduling information, title of the content, summary of the content, or content rating information. An application program interface (API) may be communicatively coupled to either the first content source 116 or the second content source 110 in the event forwarding is required of either the first type of content description information or the second type of content description information to the content list application 118. If an API is present, the API will forward either the first type of content description information or the second type of content description information, and communicate the respective content description information to the content list application 118.

Those skilled in the art will recognize that system 100 may include numerous other content sources in addition to the first content source 116 and the second content source 110, wherein said other content sources may comprise various other types of content.

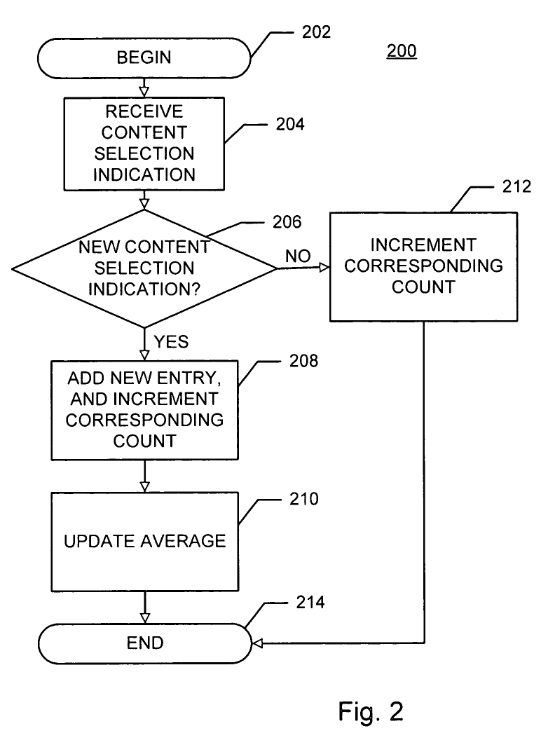

FIG. 2 is a flow diagram illustrating the list of favorite content selections feature of the present invention. Method 200 begins at step 202 and proceeds to the receipt of a content selection indication via the content selection GUI at step 204. The content selection indication is entered by a user in response to a display provided by the content selection GUI into selection device 102 coupled to set-top device 106. This content selection indication may take one of several forms, including but not limited to, actuation of a button on the selection device, a voice command, or receipt of an input via a touch screen interface. Furthermore, this content selection indication may comprise navigational information concerning the first type of content from the first content source 116 and the second type of content from the second content source 110. After the user enters the content selection indication into the selection device 102, the content selection indication is communicated to the content list application 118 from the set-top device 106.

At step 206, the present invention determines if the content selection indication has been previously selected before via the content selection GUI by the user profile. This process involves analyzing the list of favorite content selections and determining if an entry for the content selection indication already exists in the list of favorite content selections. If such an entry does exist, then method 200 proceeds to step 214, wherein the entry representing the content selection indication is incremented by 1.

However, if the present invention determines that the content selection indication is a new content selection at step 206, then a new entry associated with the content selection indication is created in the list of favorite content selections, and the new entry is assigned the value of 1. Next, the average for the selections is updated with respect to the new content selection. Method 200 then concludes at step 212.

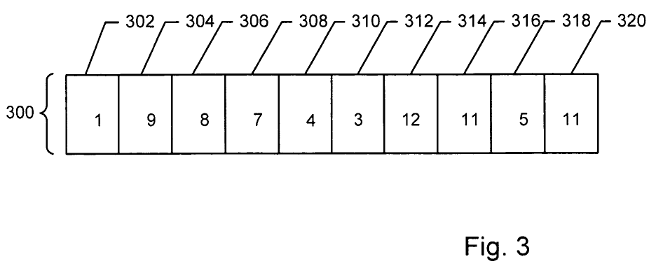

FIG. 3 is a block diagram of an exemplary data structure utilized to store and maintain the list of favorite content selections received via the content selection GUI in accordance with an embodiment of the present invention. According to the present invention, data structure 300 is an exemplary format for storing the list of favorite content selections 302-320. This data structure 300 may be stored in any location accessible to content list application 118, including but not limited to, an internal memory to the set-top device 106 or an external memory communicatively coupled or accessible to the content list application 118.

Entries 302-320 represent the list of favorite content selections received via the content selection GUI. Each entry 302-320 represents a different content selection. Furthermore, the value in each entry 302-320 represents the frequency that the user has entered that particular content selection indication via the content selection GUI.

For example, entry 302 may represent a source of VOD content. The value of entry 302 is 1, which represents a total of 1 time that the user has entered a content selection indication associated with that particular source of VOD content via the content selection GUI. The next entry 304, however, may represent a cable television channel. Because entry 304 has a value of 9, the user has entered the content selection indication associated with that particular cable television channel a total of nine times via the content selection GUI. With each content selection indication received, either an entry in data structure 300 will be incremented, or a new entry representing the content selection indication will be added to data structure 300.

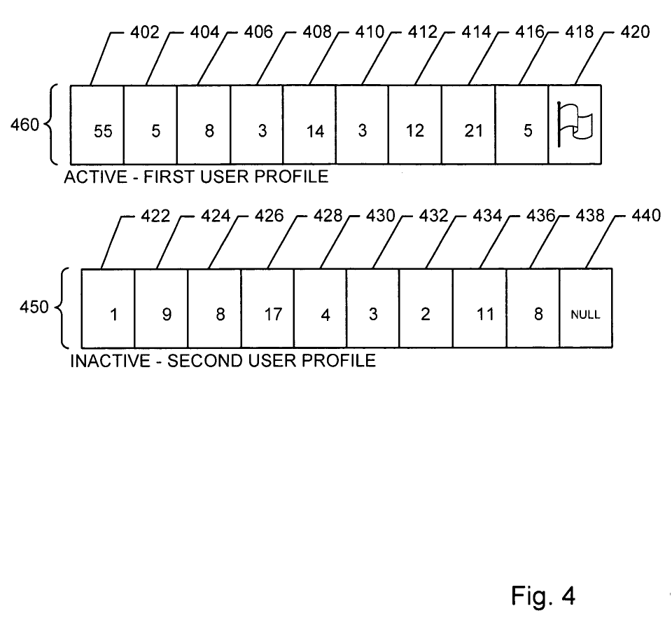

In an embodiment of the present invention providing for separate user profiles, a separate data structure 300 may exist for the one or more user profiles. FIG. 4 is a block diagram of the exemplary data structure utilized in accordance with the user profile embodiment of the present invention. In this situation, once a first user profile is activated, the data structure associated with the first user profile 460 will activate, and will be utilized to generate and maintain the list of favorite content selections 402-418. Once the first user profile is deactivated and a second user profile is activated, the data structure associated with the first user profile 460 will deactivate, and the data structure associated with the second profile 450 will activate. This activation and deactivation process may involve, but is not limited to, a simple login process, in which, for example, the user logging in successfully provides a username and password or selects a user identification element of the GUI to activate a particular user profile, and the former user profile will deactivate. Thus, the list of favorite content selections 422-428 associated with the active user profile will be utilized in accordance with the present invention.

To indicate the active data structure in the user profile embodiment of the present invention, a flag field may be present in each data structure. In FIG. 4, the flag field in data structures 460 and 450 are 420 and 440, respectively. Because flag field 420 is flagged, data structure 460 is active in the example illustrated in FIG. 4. Upon deactivation of the first user profile associated with data structure 460 and activation of the second user profile associated with data structure 450, flag field 420 will be assigned a null value and flag field 440 will be incremented to indicate that data structure 450 is active. As will be readily apparent, the two data structures (450, 460) shown in FIG. 4 may be stored as a single data structure or a single two-dimensional array. If two or more users are presented by one such array, an index into the data structure may be used, where each index value corresponds to a user.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable carrier” for purposes of embodiments of the present invention may be any medium or transmission that can contain, store, communicate, propagate, or transport the program for use by or in connection with the instruction execution system, apparatus, system or device. The computer readable carrier can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, an and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in the following claims and/or to the particular embodiment disclosed as the best mode contemplated for carrying out this invention, but that the invention will include any and all embodiments and equivalents falling within the scope of the appended claims.

1. A method of generating a graphical user interface for a user profile incorporating a first type of content description information and a second type of content description information, the method comprising the steps of:
receiving a first type of content description information from a first content source;
receiving a second type of content description information from a second content source; and
presenting an aggregated content description selection graphical user interface to the user;
tracking content selections for the user profile over the first content source and the second content source.

2. The method of claim 1, wherein tracking content selection for a user profile over the first content source and second content source comprises receiving a content selection indication corresponding to a user profile via a selection device.

3. The method of claim 1, wherein tracking content selection for a user profile over the first content source and second content source comprises receiving content description information about the first content and the second content from their respective sources.

4. The method of claim 3, wherein receiving content description information about the first content and the second content from their respective sources comprises receiving content description information via an application program interface.

5. The method of claim 1, further comprising the step of creating a list of favorite content selections for the user profile.

6. The method of claim 5, wherein creating the list of favorite content selections for the user profile comprises maintaining a data structure containing entries for each content selection.

7. The method of claim 6, wherein maintaining a data structure containing entries for each content selection comprises creating an entry representing a content selection upon receipt of a content selection indication.

8. The method of claim 6, wherein maintaining a data structure containing entries for each content selection comprises incrementing an entry representing a content selection upon receipt of a content selection indication.

9. The method of claim 5, further comprising the step of presenting the list of favorite content selections upon receipt of a favorite list presentation request.

10. The method of claim 9, further comprising presenting the list of favorite content selections as a content selection graphical user interface.

11. The method of claim 10, wherein presenting the list of favorite content selections as a content selection graphical user interface comprises presenting the list of favorite content selections via a display device coupled to a computer device.

12. An apparatus for providing a content selection graphical user interface based on content selections for one or more user profiles across a first content source and a second content source, the system comprising:
a processing unit;
an application program interface for receiving second content information about the second content from the second source, and formatting the second content information for incorporation into the content selection graphical user interface;
a set-top device coupled to a television device and to a selection device;
a selection device coupled to the set-top device, said selection device comprising a user interface for receiving content selection; and
a program module comprising instructions operative for the processing unit to:
receive a first type of content description information from a first content source;
receive second type of content description information from a second content source; and
track content selection for an active user profile over the first content source and second content source.

13. The apparatus of claim 12, wherein the program module further comprises instructions operative for the processing unit to:
create a list of favorite content selections for the user profile; and,
present a content selection graphical user interface consisting of the list of favorite content selections upon receipt of a favorite list presentation request.

14. The apparatus of claim 13, wherein the content selection graphical user interface receives commands unrelated to content selection.

15. The apparatus of claim 12, wherein said user interface of said selection device is a keypad.

16. The apparatus of claim 12, wherein said user interface of said selection device is a touch screen.

17. The apparatus of claim 12, wherein said user interface of said selection device is a microphone.

18. The apparatus of claim 12, wherein the first content description information comprises scheduling information.

19. The apparatus of claim 12, wherein the second content description information comprises scheduling information.

20. A computer-readable carrier including computer program instructions that instruct a computer to perform the steps of:
receiving a first type of content description information from a first content source;
receiving a second type of content description information from a second content source; and
tracking content selections for a user profile over the first content source and the second content source.

21. The computer readable carrier of claim 20, further including computer program instructions that instruct a computer to perform the step of creating a list of favorite content selections for the user profile.

22. A method of generating a graphical user interface for selecting content to view on a display, wherein said interface incorporates listings for at least two different types of content, said method comprising:
receiving content description information for a first type of content from a first content source;
receiving additional content description information for a second type of content from a second content source; and
presenting said content description information from both said first and second content sources in a single menu of said graphical user interface.

23. The method of claim 22, further comprising tracking content selections for a particular user profile.

24. The method of claim 23, wherein tracking content selection for a user profile comprises receiving a content selection indication corresponding to a user profile via a selection device.

25. The method of claim 23, further comprising creating a list of favorite content selections for the user profile.

26. The method of claim 25, wherein creating the list of favorite content selections for the user profile comprises maintaining a data structure containing entries for each content selection.

27. The method of claim 26, wherein maintaining a data structure comprises storing multiple user profiles in said data structure.

28. The method of claim 25, further comprising presenting the list of favorite content selections upon receipt of a favorite list presentation request.

29. The method of claim 28, further comprising presenting the list of favorite content selections as a content selection graphical user interface.

30. The method of claim 22, further comprising generating said graphical user interface with a set-top device.
